(19) United States
(12) Patent Application Publication
(10) Pub. No.: US 2006/0084482 A1
(43) Pub. Date: Apr. 20, 2006

(54) Electronic hand-held device with a back cover keypad and a related method

(75) Inventor: Sami Saila, Halikko (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/967,096

(22) Filed: Oct. 15, 2004

(51) Int. Cl. H04M 1/00

(52) U.S. Cl. 455/575.1

(57) ABSTRACT

A hand-held device such as a mobile terminal or a PDA comprising a display on one side, or alternatively, means for connecting to an external display, and a keypad on another side is presented. A light key press is visually indicated (202) to the user of the device via the one side whereas in addition to mere visual indication a heavier key press triggers the execution of a predetermined action, for example entering an associated character in the current cursor position. A related method for triggering the execution of an action is disclosed.

### FIELD OF THE INVENTION

The present invention relates generally to hand-held devices. In particular the invention concerns user interfaces, especially user input means, in hand-held terminals and PDAs (Personal Digital Assistant).

### BACKGROUND OF THE INVENTION

Modern wireless communication systems such as GSM (Global System for mobile communications) and UMTS (Universal Mobile Telecommunications System) are capable of providing the users thereof with various types of services requiring or at least supporting also different means for active interaction. Mobile terminals are typically equipped with keypad type UI with a number of buttons associated with certain characters, numbers, symbols, actions etc. Additionally, a touch pad, a mouse, a pen-usable touch screen, voice command recognition, trackball/TrackPoint, and many other techniques have been suggested to be used in connection with contemporary terminal/PDAs for supporting easy-to-use and quick device control.

Most of the widely adopted solutions, however, rely on some kind of direct physical contact between the device and the user, as e.g. sound recognition-based solutions are not feasible alternatives in cases where either the privacy of the user is endangered considering e.g. public places, crowded meeting rooms etc due to the nature of audio input, or the technology as such does not work with a sufficient level of reliability with reference to e.g. noisy environments or to long and awkward, maybe too homogenous, voice instructions that can actually be more cleverly and reliably inputted via a quick selection button or through a menu element if available.

Ongoing trend with terminal devices such as mobile terminals and PDAs dictates that the overall size of the device should be generally minimized and, at the same time, the display size be maximized to enable e.g. livable visualization of pictures and videos with both reasonable resolution and quality (colour palette/maximum number of simultaneous colours on-screen etc). Thus, in order to keep the dimensions of the device as small as possible the keypad or corresponding touchable input means thereof and respectively any other space-requiring parts are often of almost annoyingly small size, and an average big-fingered user without substantial experience with or even interest in modern terminal devices as such may find using the fully-loaded but tiny device somewhat cumbersome.

Typical prior art mobile terminal 102 is disclosed in FIG. 1, wherein the terminal front includes both display 104 and keypad/button arrangement 106 for controlling the device. Keypad 106 includes a plurality of relatively small sized/keys buttons as so large percentage of the front surface has been sacrificed to large screen 104. Respectively, a PDA's front view 108 is presented in the figure. As with most modern PDAs, display 110 consumes most of the front panel space and only a few control buttons 112 are fitted below display 110. To overcome the otherwise almost unavoidable usability problems arising from the small number of buttons display 110 may be of a touch-sensitive type and be accessible through a finger/special pointing pen press etc.

In addition to the obvious compromise that has to be made concerning the different component's placement and sizing on the terminal surface, also other drawbacks exist in such a straightforward solution. Namely, character/symbol markings are in practise necessary on the keys/keypad area to indicate to the user the response that a press of a certain button initiates. The markings may wear over time and require renovation. Still, the markings are in practise permanent and more or less fix the low level response behind the buttons from further user adjustments. Admittedly software configurable key arrangements may be used but then the pre-printed symbols on the keys at least confuse the user if differing much from the tailored active key/button press -> symbol/response configuration.

Moreover, often a single button or a corresponding pressure sensitive area in a keypad has been associated with a plurality of actions to be performed depending on the number of detected presses within a certain time period. For character whereas two short presses within a predetermined period refer to another character, and so forth. It may happen when the display and the keypad/pressure sensitive areas are located near each other that the user's hand/finger at least partially disadvantageously masks the display and/or other parts of keypad from the user while pressing a certain button. Moreover, the user may forget upon pressing the button how many sequential presses are needed to a initiate or complete certain action, and the maximum allowed time period between the subsequent presses for attaining the following pre-programmed characters may expire when the user has to re-check the button output/markings between the presses. A related problem arises from the simple one-step press procedure; upon a false button press the user has to first correct the falsely taken action before being able to perform a new try.

Even the touch-screens contain some deficiencies in a form of inadequate optical performance and inborn structural weaknesses. Furthermore, even due to normal usage, the touch-screen collects fingerprints and related dirt that lowers the sensed picture quality. As to the various pen-input based UI devices, the small-sized pens tend to get lost and without them the devices can be really frustrating or near impossible to play with. Still further, learning to use pointing pens, which may slightly differ from a device to another, may take a while.

Accordingly, notwithstanding some clever character input means like predictive T9 text input in the existing terminal devices equipped with only a limited number of keys in a keypad or other buttons, the traditional keyboard/keypad style input is in many ways still unbeatable as to the usage speed, learning curve (especially based on previous typewriter/computer/phone use), and control accuracy, as long as the size aspect is not count. However, if the device size is to be minimized, it is evident that either the number of keyboard/keypad buttons must be reduced or at least the size of a single button cut down possibly to an annoying level.

### SUMMARY OF THE INVENTION

The object of the present invention is to alleviate the defects of prior art solutions and to provide means for illustrative and fast device control being still easy to adopt.

The object is achieved by an arrangement in which a keyboard/keypad or separate keys (˜buttons) are organized on one side, e.g. back cover, of a hand-held device having a display on another, typically front, side, and indications of key etc presses or other recognised (physical) interaction are then visualized on said another side in a manner depending on the physical interaction such as the sensed pressure. Alternatively, the device may only contain an adapter to an external display instead of an internal one. In addition to mobile terminals, PDAs, and alike clearly separate hand-held devices, the device may be hand-held in the sense that it is a projection type part of a larger entity, such as a controller of manufacturing equipment, a vehicle, or some other device.

For example, when a keypad key on the back side of the device is pressed lightly, a corresponding character/symbol on the front side of the device may be highlighted with a “spotlight” type effect directly on the display or through separate visual indicators (light sources) as explained later herein. If the key is pressed more, e.g. heavily down to the bottom, the highlighted key is, for example, flashed and a corresponding action is taken at the device, e.g. function associated with such key is executed. In a somewhat typical case a character may be associated with a key and then inserted in the current cursor position as a response to a fully performed key press.

The utility of the invention is based on a plurality of issues. First, e.g. the fingers of a user even if lying on the backside keys do not hide the corresponding key symbols used for navigation on the backside but now residing on the other side of the terminal. Simultaneously, hands/fingers of the user support the device in a natural manner surely still depending on the overall design of the device itself. Secondly, the actual keypad/keyboard area does not require any character or symbol markings anymore, and thus wearing or altering thereof is not a relevant issue in contrast to the contemporary solutions. The keypad can be made waterproof by utilizing a membrane or a layer type surface, and the classic arrangement based on separate keys is not necessary although still applicable. Further, by having an SW configurable keypad “mat” or a number of likewise SW configurable separate keys on the backside, the user/device manufacturer etc can realize preferred character/symbol/action associations and mappings with buttons or pressure sensitive keypad areas. Yet, if a keypad mat is installed in a device back cover, the device may be turned e.g. 90 degrees after which the internal keypad area <-> character/symbol/action associations are automatically re-configurable to better match with the rotated device and display thereof. If the shape of the device in principle enables both one-handed and two-handed use, the button/keypad configuration may be switchable to better support either of the modes one at a time. Additional benefits of the invention are described in connection with the disclosure of the embodiments of the invention.

According to the invention, an electronic hand-held device having at least two sides and capable of receiving user input via physical contact comprises

a keypad area or a number of separate keys for sensing at least pressure, said keypad area or number of separate keys located substantially on one side of the device,

a display for visualizing information, said display located substantially on another side of the device,

a memory for storing instructions and data, and

a processor for processing instructions and data, said processor upon receiving sensation information of a first type from said keypad area or the number of separate keys relating to a certain sub-area or key of the keypad area or the number of keys and based on the instructions stored in the memory arranged to visually indicate to the user via the another side of the device the detected sub-area or key-specific sensation of the first type and

upon receiving sensation information of a second type, being at least a pressure sensation, from said keypad area or the number of keys relating to said certain sub-area or said key of the keypad area or the number of separate keys and based on the instructions stored in the memory further arranged to visually indicate to the user via the another side of the device the detected sub-area or key-specific sensation of the second type and perform a pre-determined action depending on the sub-area or key.

By defining “at least two sides” it is referred both to some “shell-shaped” hand-held devices with only two bent surfaces connected together at the ends, such surfaces acting exclusively as the sides of the device, and, on the other hand, to devices with more sides, most popular design probably being the one with four sides: so-called front, back, left, and right side, the sides named in accordance with the predetermined usage direction and view for the device.

The term “key pad area” refers herein to an area comprising either a number of discrete pressure sensitive sub-areas, i.e. keys (˜buttons, both expressions referring herein substantially to the same issue), or a membrane/layer type continuous surface with a number of distinct touch/pressure sensitive sub-areas, or both. Every sub-area may, for example, have a number of pressure sensors of if its own, or one or more areas may utilize common sensor(s) capable of detecting the location of pressure within the areas to form such sub-areas from a practical point of view. Alternatively, a number of keys, generally referring to elements for detecting pressure with at least on/off type resolution, may have been located as physically separated over the surface of the device without common parts or continuous surface to form a “key pad” as such but still to provide the device with required input information. In addition to keys and surfaces relating to the invention disclosed herein the device in question may contain additional other keys or surfaces for conventional user input, positioning of which being however not limited to any particular side of the device by the invention.

The term “physical contact” refers to either direct or indirect tangible handling of a device, e.g. pressing a keypad key. The user may utilize his finger to press a key, for example, for direct physical contact. Respectively, also middle-devices such as a pen etc can be used to input data/control information to a device via indirect physical contact. The direct/indirect physical contact may also relate to some other measured parameter than just pressure. For example, based on measuring the changes in conductivity due to a fingertip contact of conductive areas placed on the device a physical contact can be detected. Likewise, light cells or other photo-sensitive sensors may be used to detect one's finger on a certain location of the device surface based on the (absolute value or change in the) intensity of received light etc. In accordance with the current invention the sensation of the second type has a pressure component included while the sensation of the first type has more degrees of freedom and does not necessarily rely on pressure information. Accordingly, more than one parameter may be linked to (trigger) a sensation of a first or second type.

According to a second aspect of the invention, a method for triggering the execution of an action in a hand-held device comprising a display on one side and a keypad area or a number of keys located substantially on another side thereof, has the steps of

detecting a sensation of a first type on said another side of the device,

indicating at least visually said sensation of the first type to the user via said one side of the device,

detecting a sensation of a second type on said another side of the device, being at least a pressure sensation, relating to the same location with said sensation of the first type,

indicating at least visually said sensation of the second type to the user via said one side of the device, and

performing a predetermined action, said action being dependent on the location of said sensations of first and second type.

According to a third aspect of the invention, an electronic hand-held device having at least two sides and capable of receiving user input via physical contact comprises

a keypad area or a number of separate keys for sensing at least pressure, said keypad area or number of separate keys located substantially on one side of the device,

means for connecting to an external display for visualizing information,

a memory for storing instructions and data, and

a processor for processing instructions and data, said processor upon receiving sensation information of a first type from said keypad area or the number of separate keys relating to a certain sub-area or key of the keypad area or the number of keys and based on the instructions stored in the memory arranged to visually indicate to the user via another side of the device or through external display accessed via said means for connecting the detected sub-area or key-specific sensation of the first type and

upon receiving sensation information of a second type, being at least a pressure sensation, from said keypad area or the number of keys relating to said certain sub-area or said key of the keypad area or the number of separate keys and based on the instructions stored in the memory further arranged to visually indicate to the user via another side of the device or through external display accessed via said means for connecting the detected sub-area or key-specific sensation of the second type and perform a pre-determined action depending on the sub-area or key.

The above hand-held device of the third aspect, in contrast to the device of the first aspect, does not encompass a display of its own, or at least it is not used for the purpose especially set forth by the invention. Such device may be a controller of another device comprising the display, for example. Means for connecting to an external display possibly included in another device may be wired, e.g. a serial or parallel interface may be used, or wireless, e.g. in the case of IR or radio frequency transceivers. It is still possible to make use of the device itself for visually indicating the sensations, all or only some of them, to the user by introducing, for example, key and/or associated action specific lights (e.g. LEDs) to the front cover thereof.

In one embodiment of the invention, a hand-held device includes a display on the front cover and a number of keys on the back cover. Furthermore, the device includes a number of so-called “phantom buttons”, e.g. lights, on the front side to illustrate hand/finger position and associated button pressure detected on the back cover. Also alternative solutions for implementing the elements of the inventive concept are disclosed. For example, the display on the front cover may be configured to visualize also the hand/finger positions and key pressure on the back cover.

Dependent claims disclose embodiments of the invention.

### BRIEF DESCRIPTION OF THE DRAWINGS

Hereinafter the invention is described in more detail by reference to the attached drawings, wherein

FIG. 1 discloses front surfaces of both a typical prior art terminal device and a prior art PDA.

FIG. 2A illustrates one embodiment of the invention in which a terminal includes a display located on the front cover and keypad on the back cover. Furthermore, the front cover includes so-called phantom keys to visualise the current positioning of the user's fingers on the back cover keys.

FIG. 2B illustrates the back cover of the same terminal.

FIG. 3 depicts an alternative front side arrangement in which the phantom keys/button pressure sensations are visualized directly on the terminal display.

FIG. 4 is a flow diagram of a method applying the principles of the invention.

FIG. 5 is a block diagram disclosing the basic elements of a device configured to carry out the inventive method.

### DETAILED DESCRIPTION OF THE EMBODIMENT(S) OF THE INVENTION

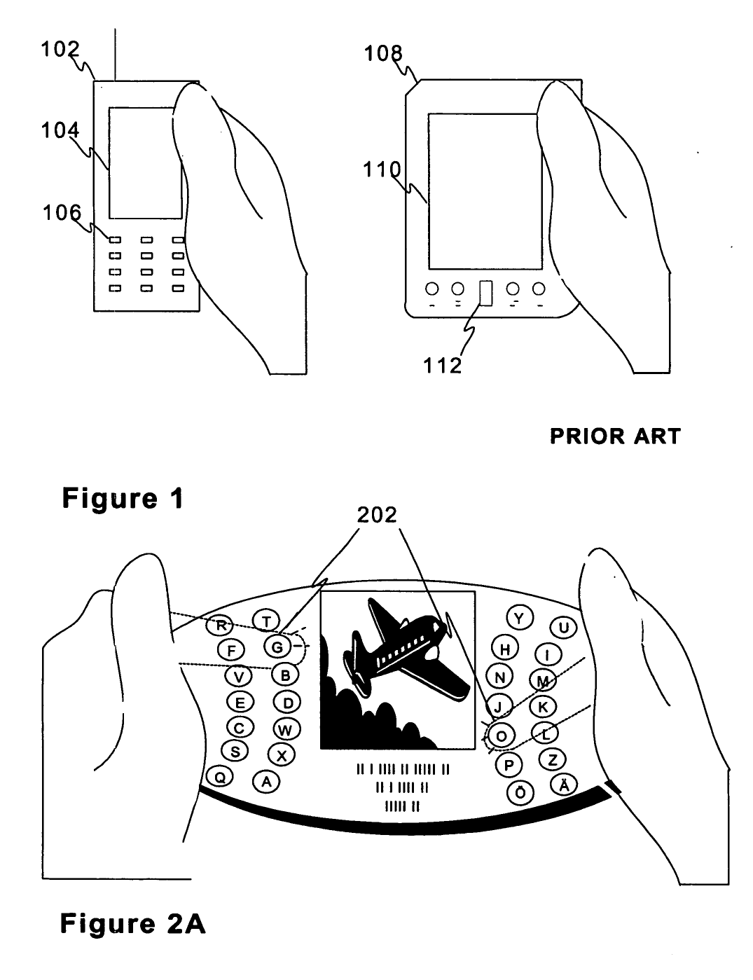

FIG. 1 was already discussed in conjunction with the description of related prior art.

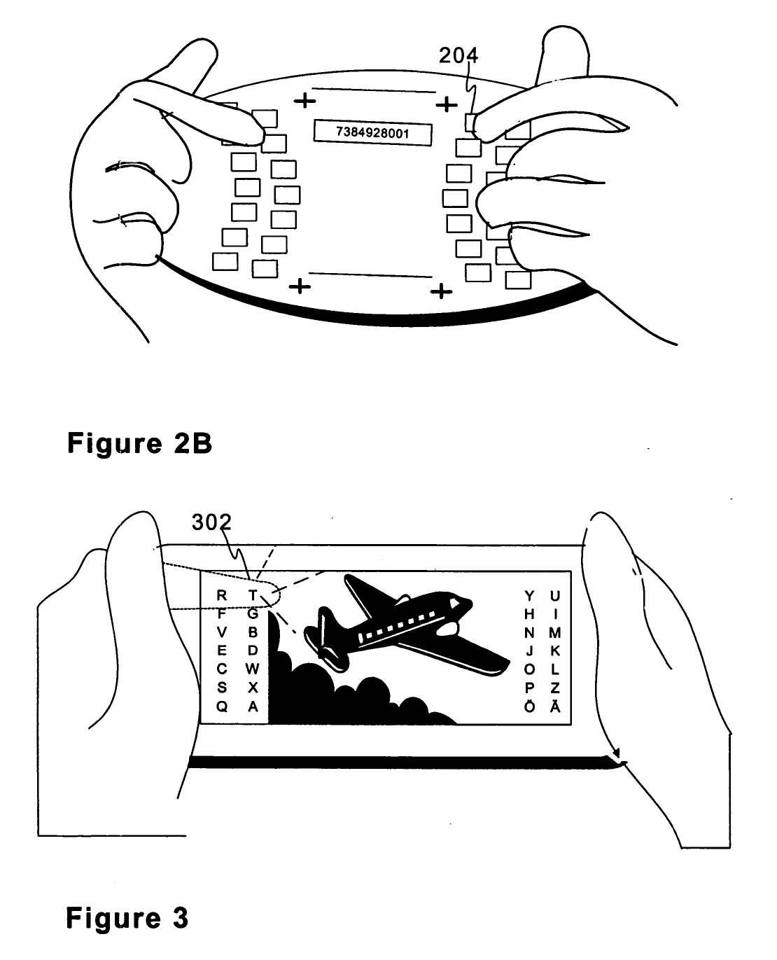

FIG. 2A discloses, by way of example only, a front side/cover view of a hand-held device, e.g. mobile terminal/game console. The device has been designed in a manner best suitable for both hands' simultaneous use and the most natural way to hold and access such a device is to grip the device from the left and right sides and support it with both thumbs on the front side whereas the rest of fingers are placed on the back side with the keypad or a number of separated buttons. Alternatively, the device could have been planned to be primarily used with one hand only in which case also the keypad/separate buttons could have been organized to cover only one section of the back cover or even of the device sidewall(s) typically then forming a right angle with the front/back surfaces if large enough for the purpose in that particular device. The latter may be a feasible option especially in cases where the device is more cube-shaped than shell-shaped. Shell-shaped models may often have large front and back covers/sides but only minimal sidewalls. In the scenario of the figure, the user presses two buttons located on the back cover, the front cover “phantom” counterparts 202 of which are then correspondingly lit, see the dotted lines referring to the fingers of the user on the backside of the device and the lit symbols on the front side. FIG. 2B shows the same scenario from the opposite direction. A keypad, a continuous key membrane/layer/touch pad, or a number of separate keys 204 etc are arranged on the back cover of the device to be easily accessible by the user's fingers. Moreover, nothing prevents the device designers from inserting some additional buttons on the sidewalls/the front side to be used with the thumbs though. As mentioned hereinbefore, a traditional way of implementing a keypad via separate keys can be superseded by utilizing e.g. SW configurable membrane/layer mats. In that case, the layer area can be configured through SW means to include a certain set of key/button sub-areas of optionally different size thus being even tailorable for each user's needs. Such personalized configurations can be made user profile dependent etc. Furthermore, the keypad area can be reconfigured automatically upon device SW update and/or new set of characters be downloaded from a network server especially in the case of a mobile terminal operable in a wireless network.

FIG. 3 discloses an alternative solution for visualizing the detected pressure on the keypad. In this example the very same display is used for both purposes, i.e. visualization of any standard information and also the pressure/action detection/selection information in accordance with the invention. One option is to display symbols corresponding to the current associations between the back cover keys and related actions on the display border areas and the residual “normal” data, “normal” data now including also data entered as response to the previous user initiated predetermined actions associated with certain keys, on the central portion of the screen. Alternatively, the symbols can be displayed on top of other, “normal”, data. Further, symbols can be lit/displayed only when the corresponding key areas are at least lightly pressed, otherwise remaining hidden. In addition, one option is to visualize symbols on the display border areas while simultaneously showing the effect of the associated action to be introduced on the central portion within the rest of “normal” data by triggering the sensation of the second type. This option could be used to preview the results to the device user as to both the associated action and the final effect thereof. In the scenario of the figure, a plurality (e.g. all if enough space on the display) of existing pressure sensitive area <-> symbol/action associations are continuously shown as dimmed on the display edges. Then, the user presses a key/pressure sensitive area corresponding to letter T 302 according to the current associations, and the related pressure sensation is visualized to the user by highlighting the T letter by further increasing the its illumination intensity or by flashing it, for example.

A “shift-key” type modifying of the visualization area on the front cover is also possible to be introduced for the realization of the invention. For example, pressing a certain key on the back cover may trigger a change in the visualization of the front cover “phantom buttons” to indicate numbers instead of characters, special characters, specific actions, etc or vice versa. Depending on the particular visualization technique used, either the phantom button area of the generic display may thus be altered as a response to a sensed key press or the purpose-specific phantom buttons be modified as such.

One of the advantages of the invention is that the user may position his fingers naturally on the device surface and keypad area/keys thereof. First, the device senses and indicates to the user the light pressure or other sensations to inform the user about the current position of his fingers and characters/symbols/actions about to be selected. Then, a subsequent more forceful key-area or button press that may or may not also contain a finger release in between the presses, or in case of a double click, a second click within a pre-determined period, is indicated in another manner being distinguishable from the previous one. Finally, an associated action, for example inserting a character/symbol in a cursor position, launching/terminating an application, sending a mail etc is performed. Advantageously the user may constantly track his fingers and movements thereof on the sensor areas of the device surface.

In addition to displaying symbols on the front side of the device via a common use or separate display or e.g. a number of symbol-specific LEDs, also an EL (electroluminescence) membrane/cover layer can be used for the purpose. The EL layer may be configured to illustrate, for example, a static set of key symbols in accordance with the prevailing keypad area/button <-> related response/action associations. User initiated button press can be then indicated by increasing the luminescence of the associated symbol on the EL surface. The EL layer or some other layer used for the purpose may include both flexible SW configurable portions and static portions with fixed characters/symbols respectively, if preferred. As the EL layer typically requires relatively high (e.g. 100V) voltage supply, the EL surface has to be covered with protective material to prevent the user from getting electric shocks from the device's front side.

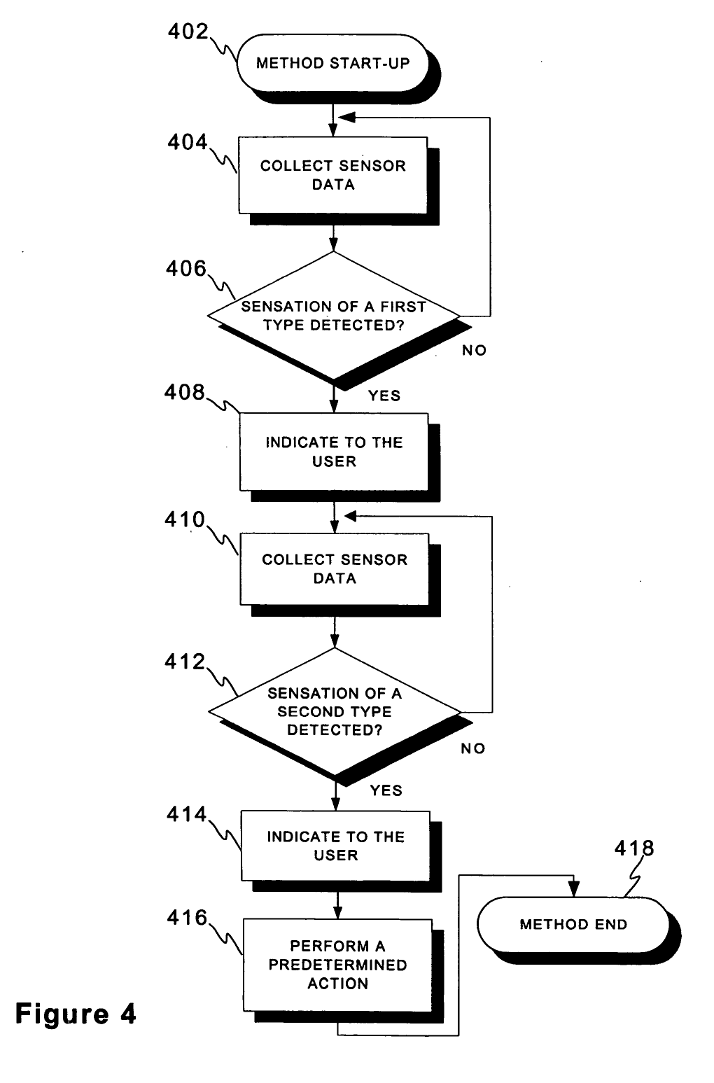

FIG. 4 discloses, by way of example only, a flow diagram describing the method of the invention. At method start-up 402 the device executing the method is, for example, turned on and/or an application utilizing the invention is started. Likewise, different variables and parameters can be initialised during the start-up phase. In phase 404 sensor data, e.g. pressure sensor information is gathered through a keypad or other prior art detection means and delivered for analysis/processing in a processor that may be implemented as a single central device or a number of smaller distributed analysis units connected at least partially together. In phase 406 it is checked, by e.g. comparing the received sensor data with a number of threshold values, whether a sensation of first type, e.g. a light button press, has validly occurred, and if that's the case, indication thereof, for example, a visual sign and/or a tactile feedback through keypad, is given 408 to the user. Otherwise, sensors remain active and phases 404 and 406 are repeated. For example, a light press may be recognized based on a pressure introduced to a key or other pressure sensitive area that while measured exceeds a certain initial threshold value but still remains below another threshold value separating light presses from heavy ones. In phase 410 more sensor data is collected e.g. during a predetermined time period or until a triggering event occurs and, in phase 412, checked against predetermined criteria. As a result, a further sensation, this time of a second type, is possibly detected, or alternatively, the execution of the method is reverted back to step 410. The second type of sensations may refer to a fully completed key press being thus direct continuum to the first type of sensations, a double click/press, a press with a certain/necessary length and strength etc. The sensation of a second type is then indicated to the user in phase 414. Substantially same or different means for giving the indications of both sensation types can be used but preferably still in a distinguishable manner as discussed hereinbefore. Method is ended in step 418, which may in this case also mean just restarting the execution from phase 404 if the method is to be run as a continuous (background) process. It is obvious to a person skilled in the art that the mutual ordering or content of method steps may be edited on a case-specific basis. Respectively, the above description of the method in accordance of the invention showed one possible chain of events in relation to the collected sensor/measurement data and detected sensations. As to the implementation aspects, a plurality of such chains may occur in parallel, each of which relating to different sensitive areas, sensors, etc handled by one common or multiple separate processing units.

Concerning especially mobile terminals and PDAs, text input prediction methods like T9 are in principle still applicable with the current inventive concept as certain keys/buttons or keypad (sub-)areas may carry several different associations with characters/symbols/actions that are then adaptively modified/executed in run-time. Aforementioned tactile feedback or button “kick-back” functionality can be implemented by utilizing e.g. a set of piezoelectric motors below the keypad surface area.

Should a keypad/keyboard be included in the device instead of few separate keys/buttons, one may find the commonly known QWERTY type keyboard arrangement as the most sensible option. QWERTY type keyboard generally includes the basic alphabet with one character per key principle with certain predetermined ordering plus some standardized additional symbols. Alternatively, truncated version thereof may be utilized for special purposes or to just save some space.

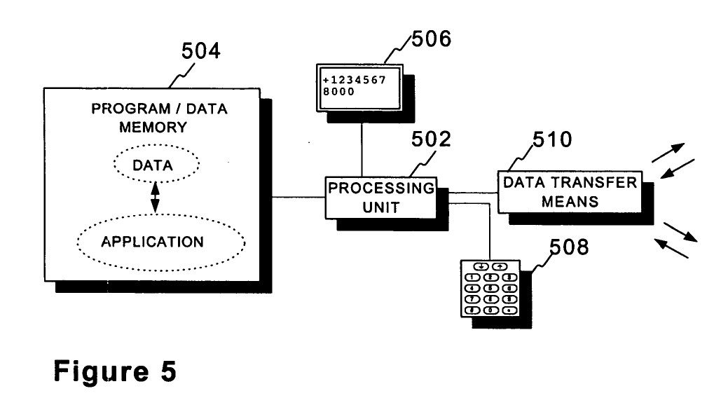

FIG. 5 depicts one option for basic components of a device like a mobile terminal (or a combination of separate elements) or a PDA capable of receiving input in accordance with the invention. The blocks have been selected especially from the invention's standpoint. Memory 504, divided between one or more physical memory chips, comprises necessary code, e.g. in a form of a computer program/application, and other data, e.g. current configuration. A processing unit 502 is required for the actual execution of the method in accordance with instructions stored in memory 504. Display 506 and keypad 508 or other applicable physical contact based user input means provide the user with necessary device control and data visualization means (˜user interface). Data transfer means 510, e.g. a fixed data transmission interface or a radio transceiver or both, or a connector to an external display, are optional components and required for handling data exchange, for example, receipt of (configuration) data from other devices and transmission of data to other devices. The invention may be implemented as a combination of tailored software and more generic hardware, or exclusively through specialized hardware such as programmable logic chips.

Code for the execution of the proposed method can be stored and delivered on a carrier medium like a floppy, a CD, a hard drive, or a memory card.

The scope of the invention can be found in the following claims. However, utilized devices, method steps, UI arrangements etc may vary depending on the target application, still converging to the basic inventive idea presented herein.

What is claimed is:

1. An electronic hand-held device having at least two sides and capable of receiving user input via physical contact, said electronic device comprising
a keypad area or a number of separate keys for sensing at least pressure (508), said keypad area or number of separate keys located substantially on one side of the device,
a display for visualizing information (506), said display located substantially on another side of the device,
a memory for storing instructions and data (504), and
a processor for processing instructions and data (502), said processor upon receiving sensation information of a first type from said keypad area or the number of separate keys relating to a certain sub-area or key of the keypad area or the number of keys and based on the instructions stored in the memory arranged to visually indicate to the user via the another side of the device the detected sub-area or key-specific sensation of the first type and upon receiving sensation information of a second type, being at least a pressure sensation, from said keypad area or the number of keys relating to said certain sub-area or said key of the keypad area or the number of separate keys and based on the instructions stored in the memory further arranged to visually indicate to the user via the another side of the device the detected sub-area or key-specific sensation of the second type and perform a pre-determined action depending on the sub-area or key.

2. The device of claim 1, wherein said one side is the predetermined back side of the device and said another side is the predetermined front side of the device.

3. The device of claim 1, wherein said sensations of first and second type are visually indicated in a distinguishable manner.

4. The device of claim 1, wherein said keypad area implements substantially a QWERTY type keyboard.

5. The device of claim 1, wherein the sensation of the first type includes a pressure sensation and relates to a light press of a keypad sub-area or a separate key.

6. The device of claim 1, wherein the sensation of the second type relates to at least one of the following: a heavy press of a keypad sub-area or a separate key, a double click of a keypad sub-area or a separate key, a press of a keypad sub-area or a separate key exceeding a predetermined time period.

7. The device of claim 1, wherein said sensation of a first or second type is based on at least one of the following: change in conductivity due to a physical contact with a conductive area placed on the device, and change in the intensity of received light detected by a photo-sensitive sensor placed on the device.

8. The device of claim 1, wherein the visual indications of sensations are given to the user by utilizing at least one of the following; a keypad sub-area or key-specific light sources on the another side, the display for visualizing the information.

9. The device of claim 1, wherein EL (electroluminescence) membrane is utilized for visual indications.

10. The device of claim 1, wherein in addition to a visual indication, tactile feedback is also used for indications.

11. The device of claim 1, wherein said predetermined action is at least one of the following: entering a character or a symbol in the current cursor position, launching/terminating an application.

12. The device of claim 1 that is substantially a mobile terminal or a PDA (Personal Digital Assistant).

13. A method for triggering the execution of an action in a hand-held device comprising a display on one side and a keypad area or a number of keys located substantially on another side thereof, has the steps of
detecting a sensation of a first type on said another side of the device (404, 406),
indicating at least visually said sensation of the first type to the user via said one side of the device (408),
detecting a sensation of a second type on said another side of the device, being at least a pressure sensation and relating to the same location with said sensation of the first type (410, 412),
indicating at least visually said sensation of the second type to the user via said one side of the device (414), and
performing a predetermined action, said action being dependent on the location of said sensations of first and second type (416).

14. A computer executable program adapted to execute the method steps of claim 13.

15. A carrier medium carrying the computer program of claim 14.

16. An electronic hand-held device having at least two sides and capable of receiving user input via physical contact, said electronic device comprising
a keypad area or a number of separate keys for sensing at least pressure (508), said keypad area or number of separate keys located substantially on one side of the device,
means for connecting to an external display for visualizing information (510),
a memory for storing instructions and data (504), and
a processor for processing instructions and data (502), said processor upon receiving sensation information of a first type from said keypad area or the number of separate keys relating to a certain sub-area or key of the keypad area or the number of keys and based on the instructions stored in the memory arranged to visually indicate to the user via another side of the device or through external display accessed via said means for connecting the detected sub-area or key-specific sensation of the first type and
upon receiving sensation information of a second type, being at least a pressure sensation, from said keypad area or the number of keys relating to said certain sub-area or said key of the keypad area or the number of separate keys and based on the instructions stored in the memory further arranged to visually indicate to the user via another side of the device or through external display accessed via said means for connecting the detected sub-area or key-specific sensation of the second type and perform a predetermined action depending on the sub-area or key.

17. The device of claim 16, wherein said one side is the predetermined back side of the device.

18. The device of claim 16 that is substantially a controller.

19. The device of claim 16, wherein said predetermined action relates to visualizing information on said external display.
